(19) United States
(12) Patent Application Publication
(10) Pub. No.: US 2005/0115094 A1
(43) Pub. Date: Jun. 2, 2005

(54) Valve train adjustment tool and method

(76) Inventor: James M. Miller, Pompano Beach, FL (US)

Correspondence Address: KEVIN P. CROSBY;BRINKLEY MCNERNEY MORGAN SOLOMAN & TATUM LLP, 200 E. LAS OLAS BLVD, SUITE 1900, FORT LAUDERDALE, FL, 33301, US

(21) Appl. No.: 10/965,013

(22) Filed: Oct. 13, 2004

Related U.S. Application Data
(60) Provisional application No. 60/510,902, filed on Oct. 14, 2003.

(51) Int. Cl. G01D 21/00

(52) U.S. Cl. 33/600

(57) ABSTRACT

A device that provides a means for a mechanic of internal combustion engines which utilize rocker arms as part of their operational design, to adjust the operating geometry of the rocker arm's pivot points in relation to the valve stem tip, in a prescribed, predetermined and accurate way, thereby increasing the efficiency of the rocker arm's operational characteristics to the operating geometry sought by the technician who installs the rocker arm to its final operating dimensions.

### CROSS-REFERENCE TO RELATED APPLICATIONS

This application claims priority upon co-pending provisional U.S. patent application Ser. No. 60/510,902 under 35 U.S.C. § 119(e).

### BACKGROUND OF THE INVENTION

Internal combustion engines operate by the controlled burning of an air-fuel mixture ignited by a timed electrical spark or injection of fuel into a sealed cylinder within an engine block which houses a piston. The piston has mechanically compressed this mixture through its reciprocating movement, dictated by a rotating crankshaft attached to the piston through a component known as a connecting rod. This compressed mixture of air and fuel is delivered into the cylinder through passages that control the volume and velocity of this air/fuel mixture, which is ignited by whatever means and immediately generates high, expanding energy from heat from this controlled burning process that forces the piston down, and through the connecting rod this linear motion is converted to circular motion which rotates the crankshaft. This process is repetitive and self driving, which creates residual (i.e. exhaust) gases that must be exhausted in a compatible and timed manner through predetermined sized and shaped passages exiting the cylinder which ideally optimize the process with the subsequent cycles of incoming air and fuel needed for continuing the process without interruption. This repetitive process requires precise control of the quantity and timing of the intake and exhaust gases traveling through these passages to and from the cylinder, by linear operating components commonly referred to as valves, which open precisely to specific heights from their closed positions where they seal tightly to a mating surface called a valve seat, precisely machined within a fixed companion engine component called a cylinder head, whereby these specific shaped and sized passages, known as ports, are contained and lead to and from their respective intake or exhaust valves.

The cylinder head is affixed upon the engine block and atop the cylinder, and is designed to seal the combustion process within the cylinder where the valves are located by a specifically shaped contour surrounding the valves, known as the combustion chamber, where the contained and compressed fuel and air ignition occurs to create the controlled, high pressure burning process that drives the self perpetuating process needed for efficient engine operation.

The valve, which employs two principle design features for precise mating to the valve seat for efficient sealing, known as the valve face, is contained on the first design feature, known as the valve head, and incorporates a precisely ground angle around its outside perimeter that corresponds to a similarly accurately ground and dimensioned mating surface within the cylinder head known as the valve seat, whereby the combustion chamber's gases are sealed and released as needed in meeting with the varying performance goals of the engine's operation. The valve's second of two principle design features is a long concentric extension from the-valve head and its sealing surface called the valve stem, whereby the reciprocating motion of the valve is constrained to a precise linear path within the cylinder head by a corresponding female tubular feature of similar concentric dimensions with precise operating clearances to reduce friction and heat, called a valve guide.

The valve guide, which constrains the valve from making excessive nonlinear motion through these close operational tolerances and assures efficient and complete sealing of the combustion chamber during the valve's seating process by keeping the valve face and valve seat precisely aligned. The valve's opening and closing process within the cylinder head is predetermined and measured in an accurate and precise way that is commonly referred to as valve lift, which is the distance the valve mating surface translates away from the valve seat.

This opening and closing process entails two additional dynamics of measurement needed for efficient operating performance, whereby the length of time this precise valve lift is maintained, known as duration, and measured degrees of rotation upon the crankshaft, and the speed in which the valve is opened to this predetermined valve lift specification, simply known as velocity, and also measured in rate of lift by degrees of crankshaft rotation. The magnitude of this linear motion, known as valve lift, is the result of several interacting components working in harmony with the valve, which comprise both linear and radial principles of motion, first initiated by a precisely designed component called the camshaft, that rotates about an axis and has individual eccentrically shaped members known as cam lobes that impart motion upon a corresponding component having an axis of linear movement mounted perpendicular to the cam's rotating axis, known as a cam follower, which usually follows two basic principles of design in mating with the camshaft, one using a precisely ground roller bearing mounted within the bottom of the cam follower that rotates upon an axis that runs parallel with the camshaft's axis of rotation, thus operating directly upon the cam face for minimal friction. The second principle of design historically used is a direct, friction contact of a nearly flat appearing surface upon the bottom of the cam follower that rides directly upon the cam face, which through a precisely ground large radius that sits upon a predetermined angle ground consistently around the full perimeter of the cam lobe, parallel to the cam's axis of rotation, a rotating force is imposed upon the cam follower to rotate it about its centerline as it operates along its linear path, thus reducing wear between the cam lobe and the cam follower from this traditional concept of cam design. The cam follower's linear motion is imparted to a second component, usually of a tubular shape and of a predetermined length, known as the push-rod, which mates or nests with the cam follower, usually through a male to female connection of a like radius between the push-rod and the cam follower, which allows the opposite end of the push rod to pivot freely from a constrained linear tracking, whereby it connects usually through a similar male-to-female radius tip connection to a third, lever-like radial operating component known as the rocker arm.

The rocker arm, comprised of an elongated body which rotates reciprocally about an axis perpendicular to its elongate length, and having two opposing ends, usually of differing lengths from its axis to create an increased operating leverage, operates simultaneously in opposing directions to converts the linear motion received through the first end connected and driven by the push-rod and cam follower by the rotating camshaft into radial motion pivoting about its axis to convey an opposing linear motion to the opposite, second end whereby its contact of a distal end of the valve stem, known as the valve stem tip, is depressed upon to displace the valve stem and cause the valve to move out of contact with the valve seat, thereby opening the valve to a desired and predetermined dimension. The valve is returned to its closed position through one of several means of resistance devices, including, but not limited to, coiled springs and devices of pneumatic pressure which connect to the valve in such a way as to impart a constant pressure against the direction of motion initiated by the camshaft and related components, known as the “valve train.” As the cam continues to rotate the cam follower falls and the force of the valve spring causes the valve to move toward its closed position, which in turn causes the rocker arm to reverse its direction and consequently the direction of the push rod so as to cause the cam follower to maintain contact with (i.e., “follow”) the cam lobe.

The first end of the rocker arm will be referred to herein as the driving end of the rocker arm, and the second end of the rocker arm will be referred to herein as the driven end. Typically, the distance from the axis of rotation of the rocker arm to the driving end of the rocker arm is different from the distance from the axis of rotation of the rocker arm to the driven end of the rocker arm. In most applications, the distance from the axis of rotation of the rocker arm to the driving end is greater than the distance from the axis of rotation of the rocker arm to the driven end of the rocker arm. The ratio of these distances is known as the “rocker ratio” and is a calibrated value designed to multiply the cam lift upon the valve by whatever factor the chosen ratio is.

The driving end of the rocker arm, which reciprocally rotates through an arc that is dictated by the combination of the cam lift and rocker arm geometries, imparts its reciprocating motion upon the valve tip. The rocker arm is secured to the cylinder head in one of several manners, but typically through a single stud running through the rocker arm, known as the rocker arm stud, or through a shaft and stand affixed to the head, known in the trade as a shaft mount or stand mount.

### SUMMARY OF THE INVENTION

The instant invention pertains to a device that provides a means for a mechanic of internal combustion engines which utilize rocker arms as part of their operational design, to adjust the operating geometry of the rocker arm's pivot points in relation to the valve stem tip, in a prescribed, predetermined and accurate way, thereby increasing the efficiency of the rocker arm's operational characteristics to the operating geometry sought by the technician who installs the rocker arm to its final operating dimensions.

The precise installation of a rocker arm on a cylinder head requires accurate pivotal alignment of the rocker arm's axis of rotation relative to the valve stem tip, which is governed by the length of the push-rod and the final locking height of the rocker arm's pivoting axis, which may include a single “stud” mounted attachment to the cylinder head, or a “stand” mounted attachment supporting the pivotal axis, or a combination of both. The principle object of the installer is to position the rocker arm so that, during operation of the engine, an imaginary line drawn between the axis of rotation of the rocker arm and a specific datum point or axis of a connecting component making contact between the driving end of the rocker arm and a predetermined point of measurement upon or above the valve stem tip is perpendicular to the elongate axis of the valve stem when the valve is halfway between its fully-closed and its fully-opened positions, which will be referred to herein as the “mid-lift position”. To thus calibrate the installation of the rocker arm, the push-rod length and the corresponding final locking height of the rocker arm's mounting must be set to an optimum length within very close tolerances.

Heretofore, there have been no successful attempts at providing a reliable and accurate apparatus and method for calculating the optimum push-rod length.

It is, therefore, a principle object of this invention to provide a method and apparatus for choosing the optimum push-rod length for an internal combustion engine.

One aspect of the instant invention is directed to a device having operational surfaces that correspond with a chosen surface of a rocker arm, which surfaces follow the rotational movement of the rocker arm about its rotational axis for the purpose of establishing the position of the rocker arm with an additional surface or feature of the instant invention. The working surfaces of the device are designed to correspond to a fixed set of reference dimensions of either the cylinder head, the rocker arm's mounting apparatus, the valve stem, valve tip or any similar surface and/or shape corresponding to same, or any other reference point on the body of the rocker arm, which provides data points that will be used by the instant invention to gauge a predictable value of radial movement of the rocker arm in question. The tool can take on any shape, and can be employed at either the closed valve position, in relation to the valve tip, or the half lift position of the valve, as well as any mathematical value or position of valve motion desired by the technician, for the purpose of establishing the optimum height of the rocker's pivot point in relation to the valve's tip.

Since the rocker arm is a radial operating device that transfers what is essentially linear movement or information from the cam follower and push-rod to a second linear operating component, the valve, the precise transfer of this motion from the cam to the valve is important and predictable in establishing specific geometrical operating characteristics for the rocker arm to optimize the camshaft's precise information. Also, since changes made in a given camshaft's design parameters will vary the consequences of motion for all accompanying components within the valve train, and since those changes will specifically affect the radial movement of the rocker arm, it is critical that adjustments be made to the mounting of the rocker arm's pivot points relative to the cylinder head. Consequently, it becomes desirable to calculate the optimum length of push rod and the optimum mounting height of the rocker arm's stud mounted or stand mounted attachment in establishing the rocker arm's axis of rotation relative to the valve tip.

On internal combustion engines having valve trains which incorporate rocker arms to open the valves, it is known within the trade that increased operating efficiency and performance can be enhanced by adjustments to the rocker arm's design characteristics, such as the ratio in which it multiplies cam lift to the valve, and also the arching motion which it goes through about its axis in opening the valve, which is determined and measured by a reference line of motion that runs between the tip of the rocker arm's contact surface (for non-roller tip designs), or through the axis of the roller (on roller tip rocker arms), and through the axis about which the rocker arm reciprocates, usually a shaft or fulcrum mounted in any variety of ways to the corresponding component known as the cylinder head. Because the rocker arm is a radial instrument that is converting linear motion on each end, it is obvious to one skilled in the trade that the tangent points for operation are critical to determining the manner of this radial motion. For this reason, an accurate method of establishing the rocker arm's pivot point in relation to the valve tip is critical for a predictable and consistent setting of the rocker arm's orientation with the valve in achieving maximum cam performance. In all cases this requires adjustment of the pivot points for the actual net motion of the valve lift; more accurately quantified by the instant invention as degrees of rocker arm rotation about its axis for whatever linear dimensions the valve lift is expected to operate in.

Previous to the introduction of the instant invention, there have been numerous devices which have attempted to assist engine builders to install the rocker arm in some form of predetermined orientation, but in all cases these attempts fell short of defining the desired geometrical operating preferences of operation, or predicting the operating limits of the rocker arms for which they were intended. In all cases known to the applicant, these previous devices all made references from only a closed valve position which offered no alternative information or means for adjustment to accommodate an accurate prediction of the intended valve lift to be adjusted for and therefore were not accurate; and in all cases the references that were made were not of a precise definition compared to the values dictated by the instant invention, which are far more precise in the setting of, and predicting for, the rocker arm's operating characteristics. Most engines being modified and improved rely on a stack of dimensions from their various valve train components, which are often not standardized until mass production is used. Because in most cases where engine modifications and adjustments to the valve train are being made, the dimensional tolerances are critical and there needs to be a means by which each engine in question can have a precise method for setting the rocker arm to compensate for variations in these engine parameters.

The instant invention permits the experienced engine builder to determine the required angle of installation for the rocker arm upon the valve so that the rocker arm's motion can be set to a predetermined valve lift by establishing the position of the rocker arm's pivot point relative to the valve tip from both a closed position of the valve, and a predetermined mid-lift point of valve motion. The instant invention accomplishes this without the use of complicated tools, excessive time in determining the above, or without the user of the instant invention totally understanding more detailed aspects of rocker arm geometry.

The instant invention accomplishes the above by providing a measuring tool which defines a surface that has a precise form which matches all or a portion of a corresponding surface upon the rocker arm, whether it is a flat plane, a prescribed curved or curvilinear shape, or any other shape. The surface in question will follow the rotational motion by which the rocker arm pivots upon its axis, and, through predetermined lengths from the rocker arm's tangent points, the instant invention incorporates a specific angle between this mating surface, and a fixed reference component to which the rocker arm mounts upon, such as the mounting stud or mounting stand, or an accurate reference plane associated to the valve, valve stem tip, or related valve spring “retainer” atop the valve spring. From the known pivotal length of the rocker arm, and the means to affix the tool of the instant invention to a fixed reference plane or mounting attachment of the rocker arm, an exact formula is derived for the aforesaid mating surfaces to the rocker arm which provide one or more of the following:
1. A specific angle for a specified valve lift, whereby only one surface of the tool of the instant invention provides a direct, singular solution that requires no further measurement,
2. A range of two or more mating surfaces having predetermined angles that provide known valve lift values whereby a formula can be derived that can be applied to any valve lift that the engine builder wishes to choose for his specific needs.
3. A means whereby a mating surface of the tool of the instant invention forms to the corresponding surface of the rocker arm in a third position of a predetermined angle of rotation with the valve opened to a specific point, to confirm the measurements derived in item 2 (above), that allows for confirmation of the accuracy of the fixed reference component or surface, and through this confirmation step a formula is derived from any errors that allow correction of the rocker arm's pivotal point in relation to the valve tip.

The instant invention provides an adjustment standard for rocker arms not previously known. It permits one who is not necessarily skilled in the trade of precision valve train adjustment to make skilled and precise adjustments by simple measurements which establish a formula used to position the rocker arm and adjust the push rod length for optimum valve train alignment.

The invention is also drawn to a method for precisely aligning rocker arms in an internal combustion engine.

These and other objects and features of the invention will be more readily understood from a consideration of the following detailed description, taken with the accompanying drawings, in which corresponding parts are indicated by corresponding numerals.

### BRIEF DESCRIPTION OF THE DRAWINGS

FIG. 1 is a side elevational view of a portion of a typical valve train which the instant invention can be employed on, showing the tool of the invention being used in a first step of the invention.

FIG. 2 is a side elevational view of the valve train components shown in FIG. 1, in a second step of the invention.

FIG. 3 is a side elevational view of the components of FIGS. 1 and 2, in a third step of the invention.

FIG. 4 is a side elevational view of the components shown in FIGS. 1-3, in a fourth step of the invention.

FIG. 5 is a side elevational view of the components shown in FIGS. 1-4, in a fifth step of the invention.

FIG. 6 is a side elevational view of the components shown in FIGS. 1-5, in a sixth step of the invention.

FIG. 7 is a perspective view of an embodiment of the tool of the invention.

FIG. 8 is a right side elevated view of the tool.

FIG. 9 is a left side elevated view of the tool.

FIG. 10 is an elevated view of the adjusting nut of the invention.

### DETAILED DESCRIPTION OF THE PREFERRED EMBODIMENTS

The example used in the disclosure herein is directed to a 350 cubic inch Chevrolet engine, where the valve lift measurements of 0.500 inch and 0.700 inch are used as reference dimensions. However, the invention can be used for any valve train application. For example, for Ford 302 cubic inch and 351 Windsor engines, the measuring tool 50 is used to perform the methods of this invention but the measurement reference dimensions are 0.522 inch and 0.732 inch.

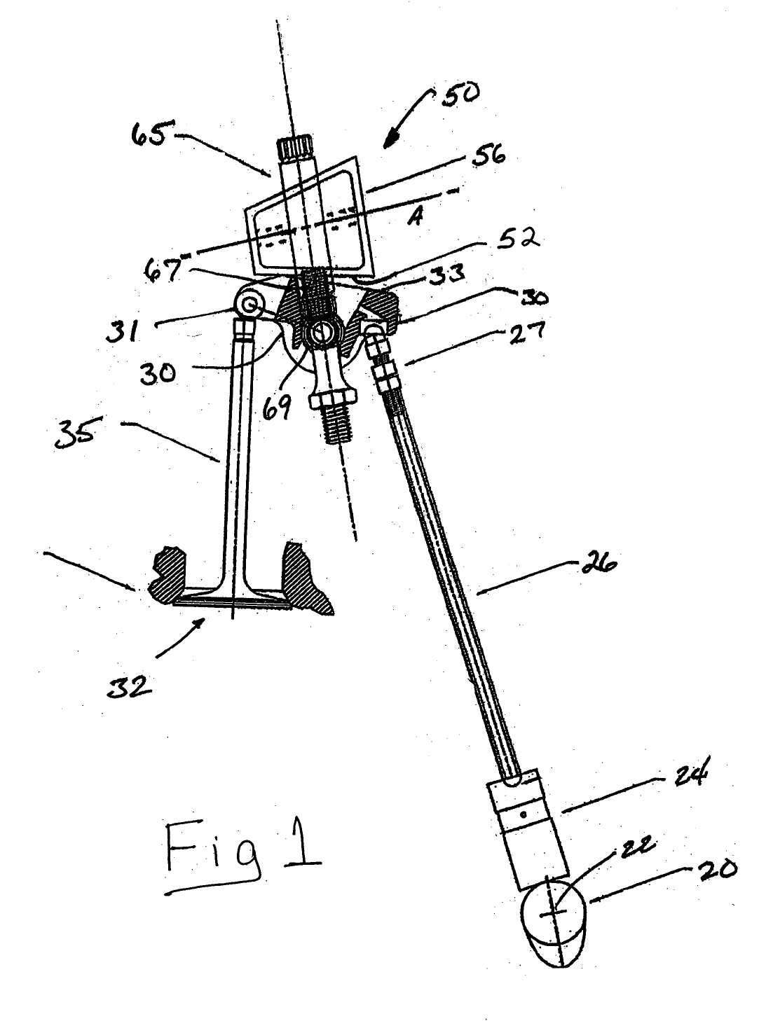

FIG. 1 shows a typical valve train arrangement employing a cam shaft 20 with a representative cam lobe 22, a cam follower 24, a push-rod 26, a rocker arm 30, and a valve 32.

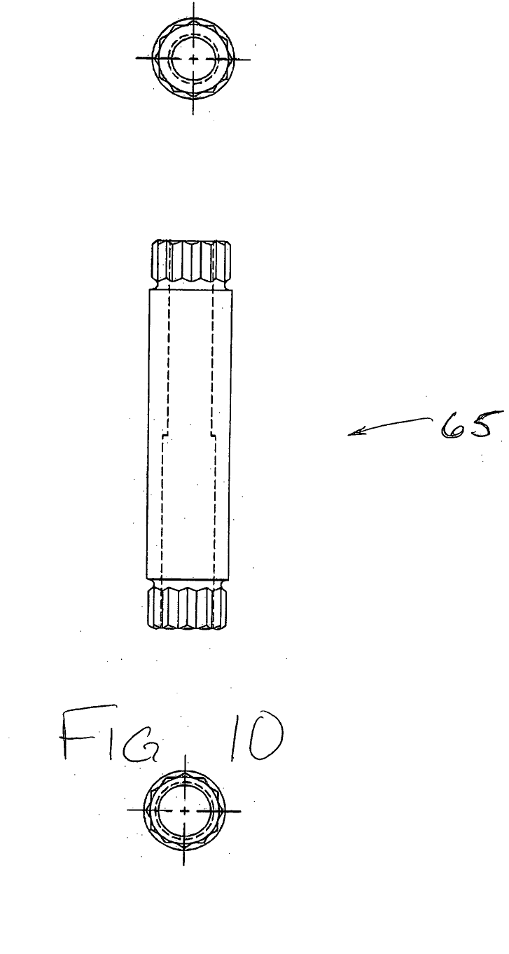

The tool 50 can be of any polygonal shape. In the embodiment shown herein, it is four sided, having a first measuring face 52, a second measuring face 54, and first and second end faces 56, 58, respectively. A representative example of the tool 50 of this invention is shown in FIGS. 1-9.

Tool 50, and the methods set forth herein, not only permit the setting of the rocker arm geometry properly, but also permit for the adjustment of the positioning of the rocker arm in the event that the angle of the rocker arm stud emerging from the cylinder head is not set to factory or other expected specifications.

Tool 50 has three usable surfaces, sides 52, 54 and 56, to establish proper installed rocker arm geometry. All three sides are designed to be laid atop the rocker arm's upper or “measuring” face, such as at 33, during the various steps of the method to be set forth below. Sides 52 and 54 of tool 50 are designed to work together to establish initial reference push rod dimensions which are then applied to the specific valve lift for the engine in determining the final push rod length. In the embodiment shown herein, measuring face 52 of tool 50 is calibrated to lie flush with rocker arm upper surface 33, regardless of the contour of that surface. In other words, measuring surface 52 of tool 50 is adapted to mate (i.e. lie flush with) the contour of rocker arm upper surface 33. In the embodiment shown in the drawings, that surface is planar. However, that surface could be curvilinear, curved or of any contour desirable. All that is required is for the surfaces 52 and 54 of tool 50 to be oriented parallel to or at least aligned with some portion of upper surface 33 of rocker arm 30 so as to become aligned therewith.

A method of using the invention will now be disclosed. The specific dimensions used are simply by way of example and not by way of limitation, as it will be understood to those of skill in the art that the principles of this invention can be applied to engines having any one of a number of valve train dimensional parameters and characteristics. In a first step, a rocker arm is installed on the cylinder head rocker arm stud 67 with an adjustable push rod 26 with the cam 20 in its closed position. Adjustable nut 65 is placed upon rocker arm stud 67. Nut 65 is internally threaded to be received upon the external threads of stud 67. As best seen in FIG. 10, Nut 65 employs internal threads along one half of its hollow interior and a different diameter thread pattern along the second half of its hollow interior surface. In this way, nut 65 can be used across multiple applications, since different engines have different sized rocker arm studs. Nut 65 may be loosely threaded down upon stud 67 until the bottom end of nut 65 makes contact with rocker arm trunnion 69. Then, tool 50 is placed upon nut 65 by passing nut 65 through first aperture 51 defined by tool 50.

Unless, the angle of first measuring face 52 relative to the central axis is calibrated for the precise valve lift for the particular valve train geometry of that particular engine, surface 52 will not lie flush with surface 33. As shown in FIG. 1, a gap is present between surfaces 52 and 33. The misalignment may be either positive or negative, i.e. the gap may be either to the right or to the left of nut 65. In FIG. 1, the gap is to the right.

The next step in the method is to adjust the length of push rod 26 by manipulating adjustment nuts 27 and 65 so that push rod 26 is made either longer or shorter (in the case shown it will have to be made longer) so that surface 52 and 33 mate together. It will be appreciated that, in order to do this, the axis of rotation of trunnion 69 will move vertically upward relative to rocker arm stud 67, thus changing the position of the central axis of the trunnion relative to the axis of rotation of roller tip 31.

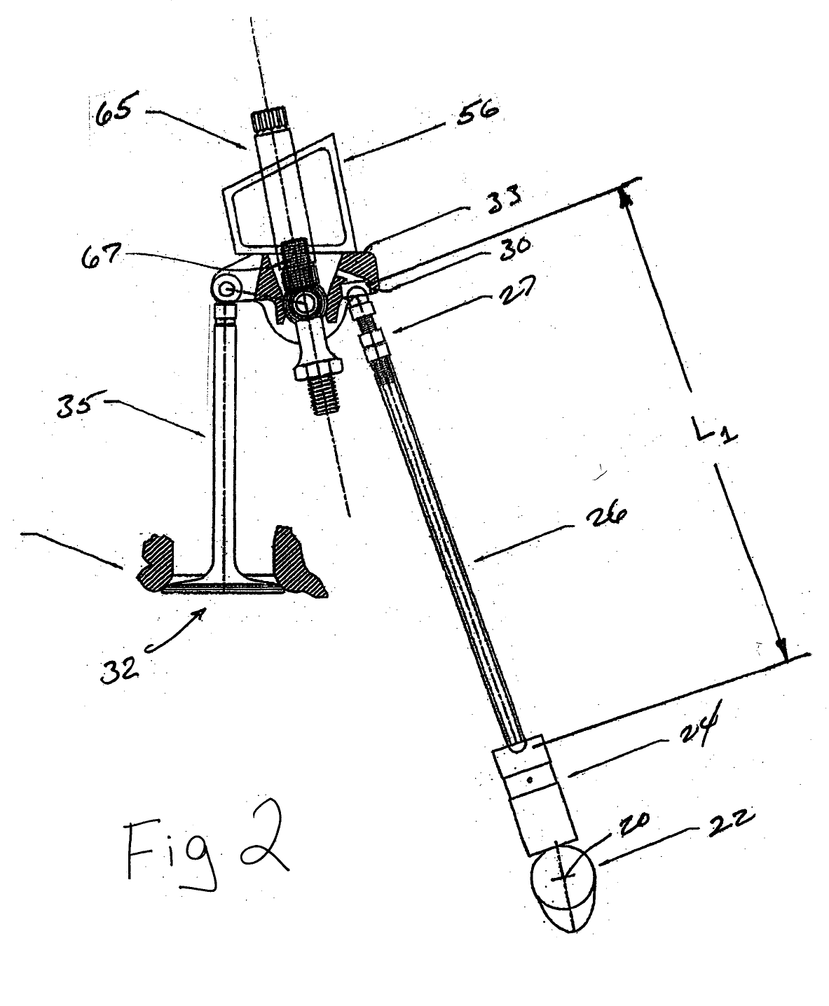

Once this is accomplished, the configuration shown in FIG. 2 is achieved. The new push rod length L, is written down or committed to memory to be used in a later calculation.

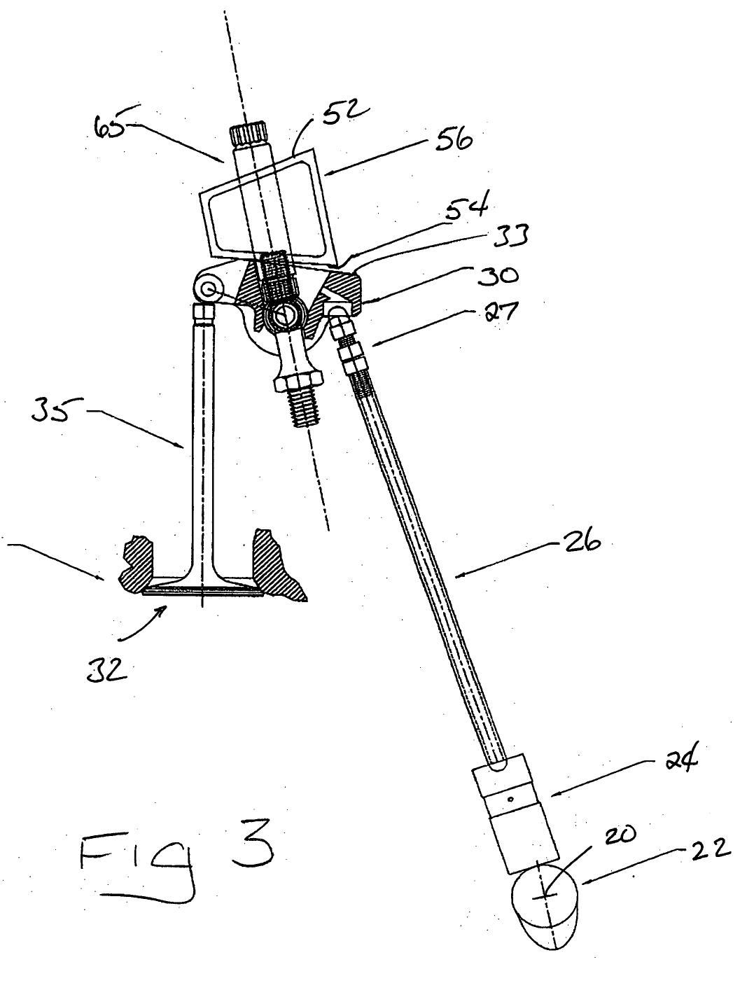

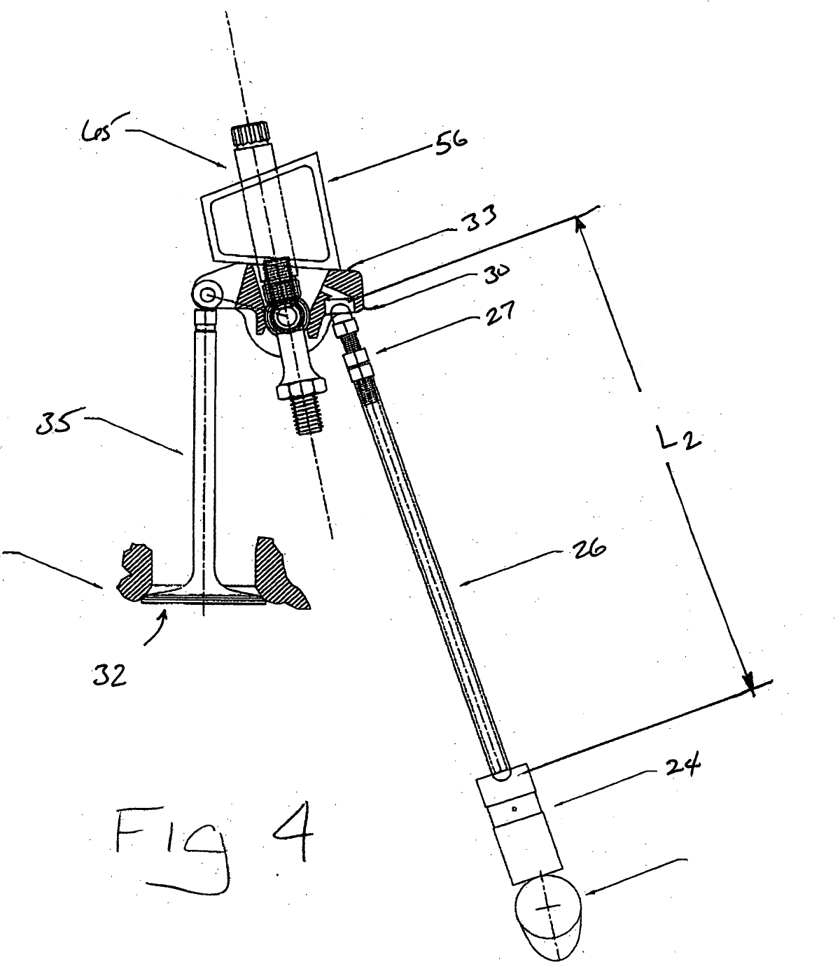

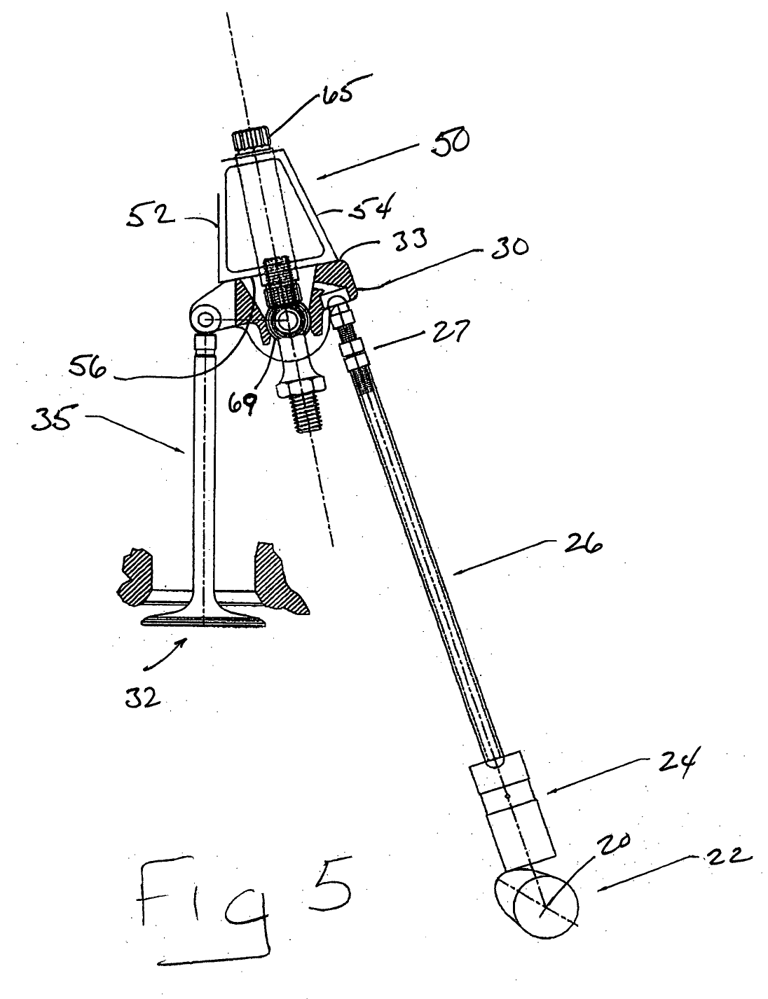

In a next step, tool 52 is taken off of nut 65, turned over, and placed back upon nut 65 through the same bore 51, such that measuring surface 54 is now face-down upon rocker arm upper surface 33. Again, if the angle of measuring surface 54 relative to the elongated axis A of board 53 is calibrated for the particular valve train geometry being used, e.g. 0.700 inch valve lift, surfaces 54 and 33 will mate at the particular push rod length being used. However, if as in the case in FIG. 3 there is a gap between surfaces 54 and 33, the length of push rod 26 and the height of rocker arm 30 (via adjustment of nut 65) will have to be changed to the orientation shown in FIG. 4. This results in a new push rod length L₂ as shown in FIG. 4. This valve should also be written down or committed to memory.

In a next step, push rod lengths L₁ and L₂ are subtracted from each other to arrive at a dimension which will be used in a later calculation.

The measurement steps also include checking the actual lobe lift of the cam, and multiplying it by the ratio of the rocker arm to arrive at the theoretical valve lift. If a mechanical cam is being used, the valve lash should be subtracted from this figure. This will give a final theoretical valve lift but will be divided in half to arrive at the proper half valve lift. In the example given, this figure may be, for example, 0.600 inch. The angle of surface 52 relative to a plane coinciding with surface 56 of tool 50 is proportional to a first “assumed valve lift”, in the example given that valve lift being equal to 0.500 inch. The angle of surface 54 relative to a plane coinciding with surface 56 is proportional to a second “assumed valve lift”, which in the example is 0.700 inch. These valve lift dimensions are chosen to comprise high and low ends of a range within which the actual valve lift for that engine will lie. For example, if surface 52 is calibrated, i.e. oriented, to correspond to a 0.500 inch valve lift, and surface 54 is calibrated, i.e. oriented, for a valve lift of 0.700 inch, such a tool is suitable for use in setting up the rocker arm geometry for an engine having a valve lift falling anywhere within and inclusive of the end points of that range.

In the steps shown in FIGS. 1 and 2, once the measuring surface 52 becomes flush with the upper surface 33, the rocker arm's closed valve position is set precisely for the correct height required for operation at that first reference dimension valve lift. In the example herein, that would be 0.500 inch. Once tool 50 is turned over and placed back upon nut 65, and surface 54 is placed flush with upper surface 33 of rocker arm 30 by adjusting push rod 26 and adjusting nut 65, that sets the rocker arm closed position for precisely the correct height required for operation at the second reference dimension valve lift, which in the example given is 0.700 inch.

In a further step in the method, the difference between push rod lengths L₁ and L₂ is divided by the magnitude of the difference between the first reference dimension valve lift and the second reference dimension valve lift. In the example given that magnitude is 0.200 inch. Assuming the difference between push rod lengths L₁ and L₂ is 0.165 inch, dividing the difference in push rod lengths by the magnitude of the difference between the first and second reference dimension valve lifts yields value of 0.825 inch (0.165″-0.200″=0.825″). This yields the result that for every ten thousandth of an inch (0.010″) change in valve lift, the push rod length will need to be changed approximately eight thousandths of an inch (0.00825″).

In the next step, the theoretical valve lift of the cam (in the example given that figure is 0.600 inch) is subtracted from the high end of the reference dimension valve lift figures (in the example that is 0.700 inch). In our example, the theoretical engine's valve lift is 0.600 inch, yielding a difference of 0.100 inch (0.700″-0.600″=0.100″).

In the next step, the foregoing difference of 0.100 inch is multiplied by 0.825 inch to yield a product of 0.0825 inch.

In the final step, the push rod length is made to equal length L₂ plus 0.0825 inch.

If the valve lift of the actual engine is greater than the second (high end) reference dimension valve lift, instead of adding the 0.0825 inch to the L₂, one would subtract 0.0825 inch from length L₂, since increasing the valve lift requires a decrease in the length of the push rod due to the positioning of the axis of rotation of the rocker arm, i.e. trunnion.

Once the optimum push rod length is selected, the rocker arm is placed back onto the rocker arm mounting stud or mounting stand for testing at the half lift position of the valve with full valve spring pressure. First, the engine should be rotated one full revolution to check the actual net valve lift, and the valve lash should be set and taken into consideration for a further step. If a hydraulic cam is used, this step need not be carried out (unless a solid mockup cam follower is used). Confirming the net valve lift should be done before any final decision on push rod length is made. If the net valve lift is not within 0.015 inches of the theoretical valve lift previously used in the calculation of push rod length, the push rod length should be adjusted for true net valve lift. The push rod previously utilized will remain the same. The calculation should be re-performed using the true net valve lift instead of the theoretical net valve lift.

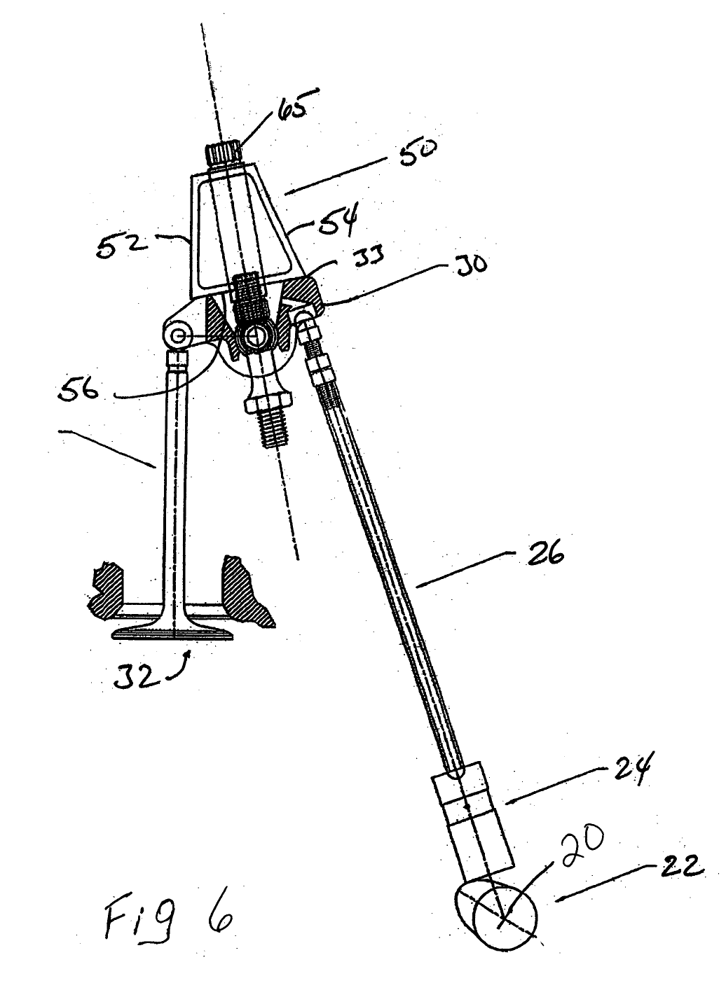

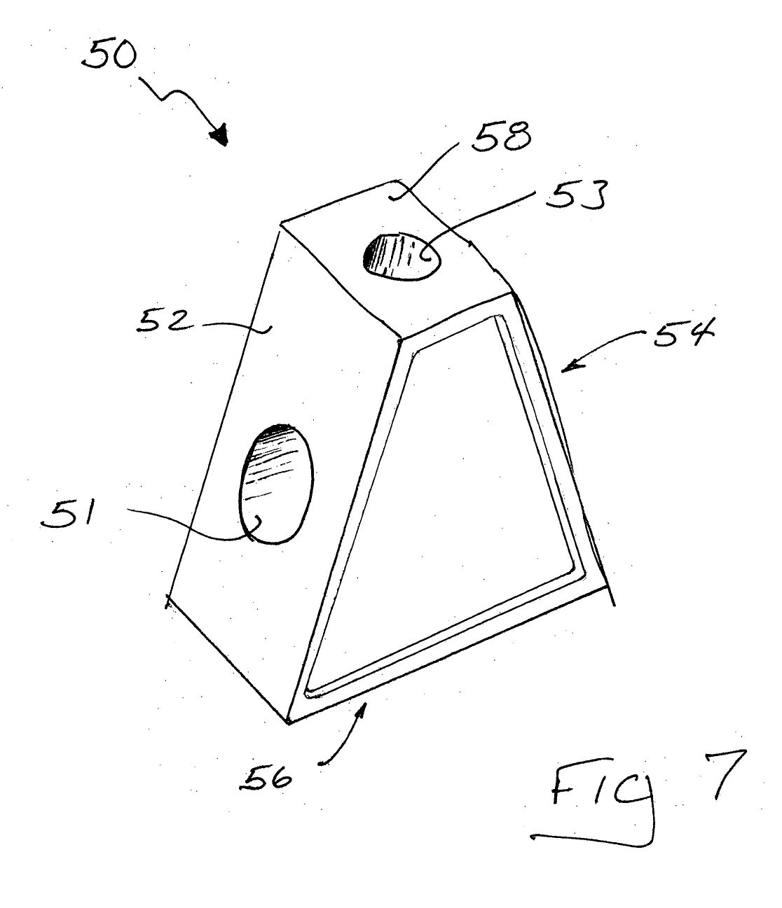

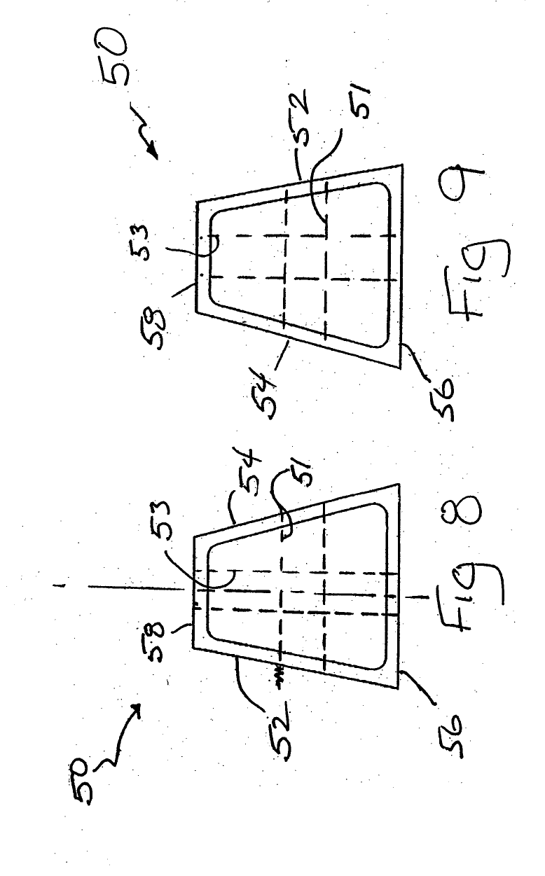

The method of use of the tool 50 in connection with FIGS. 5 and 6 will now be described. The angle of the rocker arm stud (“stud angle”) may be confirmed using the tool of the instant invention. If the stud angle is incorrect, so too is the geometry of the valve train. In order to confirm the stud angle using the tool 50, the engine should be turned over so that the valve associated with the stud angle being analyzed is at its half lift position, i.e. half open, with fully operational valve springs, taking a reading directly from the valve spring retainer. Surface 56 of tool 50 should be set atop the rocker's measuring surface 33 to confirm that it is flush across the entire surface. If any gap is present the stud angle for the engine is off and an additional adjustment should be performed.

To correct the misalignment, while still at the half lift position of the valve, slowly rotate the engine in the direction required to close the gap between surface 56 of tool 50 and upper surface 33 of rocker arm 30, while taking note of how many thousandths of an inch it takes the valve to move until this gap is closed, i.e. surfaces 56 and 33 are flush. The error seen during this step was actually created during the first steps of setting the push rod length at closed valve, since the positioning of the rocker arm and changing the push rod lengths were made based on an inaccurately positioned rocker arm stud.

To correct the error at the push rod the user must divide the magnitude of the valve's motion in going form the half open position to the position it was in when surfaces 56 and 33 became flush by the rocker arm ratio. In the example given herein, with a 0.600 inch theoretical valve lift, which would be set at 0.300 inch valve lift at its half open position, would require 0.030 inch more valve lift to let the tool 50 fall flat on the top of rocker 33. For a rocker ratio of 1.50:1, one would divide the extra valve lift of 0.030 inch by this ratio (0.030/1.50=0.020) to see that the push rod length needs to be modified by 0.020 inch. If it was necessary to open the valve further (as opposed to closing it) to cause the tool surface 56 to lay flush with corresponding surface 33, the push rod length needs to be decreased by the calculated amount (in the example given that amount is 0.020 inch), and vice versa.

It is to be understood that the actual final push rod length determined may be used to manufacture non-adjustable push rods, or adjustable push rods may also be used in the operation of the engine.

The invention disclosed herein has been described in the most practical and preferred embodiment known to the inventor. It is to be understood, however, that departures to the structures and methods described herein are contemplated to be within the scope of the invention.

1. A tool for measuring the installation geometry of a rocker arm in an internal combustion engine, the internal combustion engine including a combustion chamber, a valve reciprocable between a first, fully open position and a second, fully closed position within the combustion chamber, a cam follower reciprocable upon a cam shaft lobe, a rocker arm extending between a tip of the valve and a driving end of the cam follower, adapted to translate linear reciprocal movement of the cam follower to linear reciprocal movement of the valve, the rocker arm defining a measuring surface, a rocker arm stud attached to an engine cylinder head to which the rocker arm may be removably attached and about which the rocker arm reciprocally pivots, the tool comprising:
a tool body defining at least three surfaces each of which are adapted to mate with the measuring surface of the rocker arm;
the tool defining a first bore through which is adapted to be placed the rocker arm stud during a first and second measuring step; and
the tool further defining a second bore through which the rocker arm stud is adapted to be placed during a third measuring step.
